(19) United States
(12) Patent Application Publication
(10) Pub. No.: US 2018/0338652 A1
(43) Pub. Date: Nov. 29, 2018

(54) TOILET SHROUD WITH DIFFERENT SQUAT POSITIONS

(71) Applicant: C&D Zodiac, Inc., Huntington Beach, CA (US)

(72) Inventor: Frans Erkelens, Huntington Beach, CA (US)

(21) Appl. No.: 15/985,577

(22) Filed: May 21, 2018

Related U.S. Application Data
(60) Provisional application No. 62/510,144, filed on May 23, 2017.

(51) Int. Cl. A47K 17/02; B64D 11/02; E03D 11/13

(52) U.S. Cl. CPC A47K 17/028; B64D 11/02; E03D 11/04; A47K 17/022; E03D 11/135

(57) ABSTRACT

A toilet assembly that includes a shroud portion, a main body portion extending generally forwardly from the shroud portion, and first and second intermediate protrusions extending generally forwardly from the bowl portion. The main body portion includes a bowl portion that includes a bottom and a top. The top includes an upper surface that defines a seat adjacent surface. The first and second intermediate protrusions are located vertically between the top and the bottom of the bowl portion and are configured such that a user can position their feet thereon.

### CROSS REFERENCE TO RELATED APPLICATIONS

This application claims the benefit of U.S. Provisional Application No. 62/510,144, filed May 23, 2017, the entirety of which is incorporated herein by reference.

### FIELD OF THE INVENTION

The present invention relates generally to a toilet having multiple foot placement positions, and more particularly to a toilet module having multiple foot placement positions for use in an aircraft lavatory.

### BACKGROUND OF THE INVENTION

Commercial aircraft, such as the Airbus A320 or Boeing 737, are typically constructed from modular components, the size, weight and construction of which are dictated by many considerations, including fuselage dimensions, aesthetic and safety. Many of these requirements are imposed by law or regulation. Aircraft components, such as overhead stowage compartments, seats, lavatories, galleys, lighting systems, etc. are all required to function within strictly confined spaces.

Manufacturers of aircraft are constantly refining interior aircraft designs to achieve more comfort and utility for passengers and crew within carrier-imposed restraints on cost, weight, maintenance down-time, and safety. Commercial passenger aircraft generally include lavatories for use by passengers and crew that include a toilet therein. There are a surprisingly large number of countries and cultures in Asia, the Middle East and Africa where squatting toilets are a part of daily life. The locations where squat toilets easily outnumber sitting toilets include the two most populous countries in the world today: China and India. In many other countries squat toilets can be found in large numbers, especially in public places, as in public transportation. It is estimated that more than 3.5 billion people around the world are using the squatting position every day.

### SUMMARY OF THE PREFERRED EMBODIMENTS

In accordance with a first aspect of the present invention there is provided a toilet assembly that includes a shroud portion, a main body portion extending generally forwardly from the shroud portion, and first and second intermediate protrusions extending generally forwardly from the bowl portion. The main body portion includes a bowl portion that includes a bottom and a top. The top includes an upper surface that defines a seat adjacent surface. The first and second intermediate protrusions are located vertically between the top and the bottom of the bowl portion and are configured such that a user can position their feet thereon. In a preferred embodiment, the first and second intermediate protrusions each include an upper surface that defines an intermediate position surface that is generally horizontal.

In a preferred embodiment, the bowl portion further includes first and second squat extension portions extending outwardly therefrom that each include an upper surface that defines a squat position surface that is generally horizontal. Preferably, the bowl portion includes a generally ring-shaped seat adjacent surface and the squat position surfaces extend outwardly from the seat adjacent surface. In a preferred embodiment, the squat position surfaces include front and outer edges that are generally perpendicular to one another and the first and second squat extension portions include a front surface and an outer surface that are generally perpendicular to one another.

In a preferred embodiment, the first and second intermediate protrusions are separate from one another. In another embodiment, they can be a single protrusion that includes a common surface with two places for the user's feet. Preferably, the first and second squat extension portions include tread portions thereon. The tread portions can extend from the squat position surface to the seat adjacent surface.

In accordance with another aspect of the present invention there is provided toilet assembly that includes a shroud portion, and a main body portion extending generally forwardly from the shroud portion. The main body portion includes a bowl portion that includes a bottom and a top. The top includes an upper surface that defines a seat adjacent surface, and the bowl portion further includes first and second squat extension portions extending outwardly therefrom. The first and second squat extension portions each include an upper surface that defines a squat position surface that is generally horizontal. In a preferred embodiment, the bowl portion includes a generally ring-shaped seat adjacent surface and the squat position surfaces extend outwardly from the seat adjacent surface. Preferably, the squat position surfaces include front and outer edges that are generally perpendicular to one another and the first and second squat extension portions include tread portions thereon. In a preferred embodiment, the tread portions extend from the squat position surface to the seat adjacent surface.

In a preferred embodiment, the toilet assembly further includes first and second intermediate protrusions extending generally forwardly from the bowl portion. that are located vertically between the top and the bottom of the bowl portion. The first and second intermediate protrusions are configured such that a user can position their feet thereon. Preferably, the first and second intermediate protrusions each include an upper surface that defines an intermediate position surface that is generally horizontal.

In accordance with another aspect of the present invention, there is provided a toilet seat assembly that includes a pivotable cover, and a pivotable seat that includes a ring portion that defines a seat surface and first and second squat extension portions extending outwardly from the ring portion. The first and second squat extension portions each include an upper surface that defines a squat position surface that is generally horizontal. In a preferred embodiment the seat and cover are pivotable along the same pivot axis.

Preferably, the squat position surfaces include front and outer edges that are generally perpendicular to one another. In a preferred embodiment, the first and second squat extension portions include a front surface and an outer surface that are generally perpendicular to one another. Preferably, the first and second squat extension portions include tread portions thereon. The tread portions preferably extend from the squat position surface to the seat surface.

In the present invention, generally, footstep provisions are integrated into the toilet and or an additional squat toilet ring (similar to a traditional toilet seat yet specialized for squatting). In an embodiment, the invention includes safety handles (assist handles) located in such a way that they are in reach while using the squat provisions or footsteps.

The present invention is a toilet that includes provisions for a person to use the toilet with their feet in two or three different positions. The first position being the regular use/sitting position (typical in western-style toilets), the second being the sitting position with raised legs (referred to herein as the “intermediate position” or the “squatty potty” position) and the third being the squatting position (typically used in toilets in countries such as India). Some of the different positions can provide use of the toilet without sitting on the seat and use of toilet while seated while legs are elevated from the floor. Furthermore, the invention can include built in safety features, such as handles and braces. In a preferred embodiment, the toilet assembly is used in an aircraft lavatory. In different embodiments, the platforms for the user's feet can be positioned on the toilet itself, on the toilet seat or a combination thereof.

In a first preferred embodiment, the toilet shroud includes squat provisions integrated therein. Provisions are such that it has structural reinforcements to allow people of percentiles (of weight) to safely use them. Structural reinforcements may be incorporated underneath the shroud to transfer the loads while in use. In a preferred embodiment, integrated anti-slip provisions are included. The shape allows for use in the squat position, the raised legs position (the intermediate position) and regular use. In another embodiment, only one of the provisions set (for the squat position or the intermediate position) can be included.

In another preferred embodiment, the toilet includes an additional squat “seat” or intermediate seat/ring that is pivotal and located between the standard toilet seat and the toilet rim. The toilet can also be used in the squat position (by standing on the intermediate seat/ring) or by lowering the standard toilet seat to use while seated.

The additional squat seat can have structural reinforcements or it can be manufactured from a strong enough material to allow people of percentiles to safely use it. Structural reinforcements can be incorporated underneath the existing shroud to transfer the loads while in use. Integrated anti-slip provisions or tread members or portions can be included.

Assist handles on the walls or doors of the lavatory can be included. The location of the handle(s) are not limiting, but will preferably be located on the walls for hand-holds to ensure safety while either squatting on top of the squat seat or shroud squat provisions. Handles can be used when squatting and/or they will be within easy reach to the person if needed when turbulence occurs in flight.

Described herein is a preferred embodiment of a toilet and shroud that include multiple foot placement positions. In a preferred embodiment, the toilet is used in an aircraft lavatory. However, this is not a limitation on the present invention, and the description herein of the toilet being used in an aircraft is only exemplary. In a preferred embodiment, the toilet assembly can be used with the attachment assembly taught in U.S. Pat. No. 9,896,213, issued on Feb. 20, 2018, the entirety of which is incorporated by reference herein.

### BRIEF DESCRIPTION OF THE DRAWINGS

The invention may be more readily understood by referring to the accompanying drawings in which:

FIG. 1 is a perspective view of a toilet assembly in accordance with a preferred embodiment of the present invention;

FIG. 2 is a perspective view of the toilet assembly of FIG. 1 showing a person in the intermediate position;

FIG. 3 is a perspective view of the toilet assembly of FIG. 1 showing a person in the squat position;

FIG. 4 is a perspective view of the toilet assembly of FIG. 1 showing a person in the regular position; and

FIG. 5 is a perspective view of a toilet seat assembly in accordance with another preferred embodiment of the present invention.

Like numerals refer to like parts throughout the several views of the drawings.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are references to the same embodiment; and, such references mean at least one of the embodiments.

Reference in this specification to “one embodiment” or “an embodiment” means that a particular feature, structure, or characteristic described in connection with the embodiment is included in at least one embodiment of the—disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

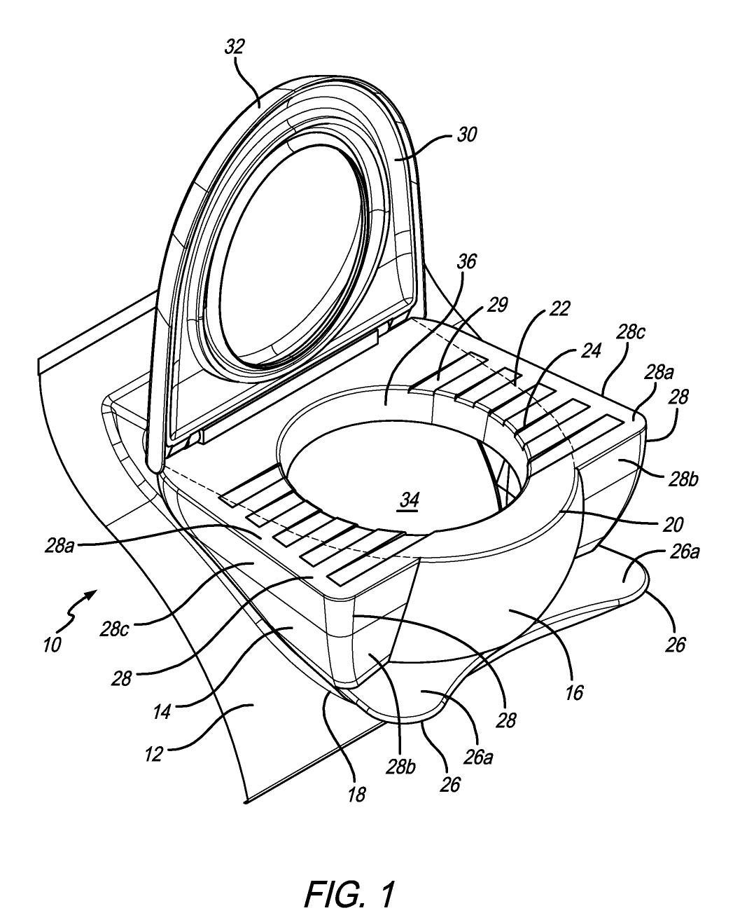

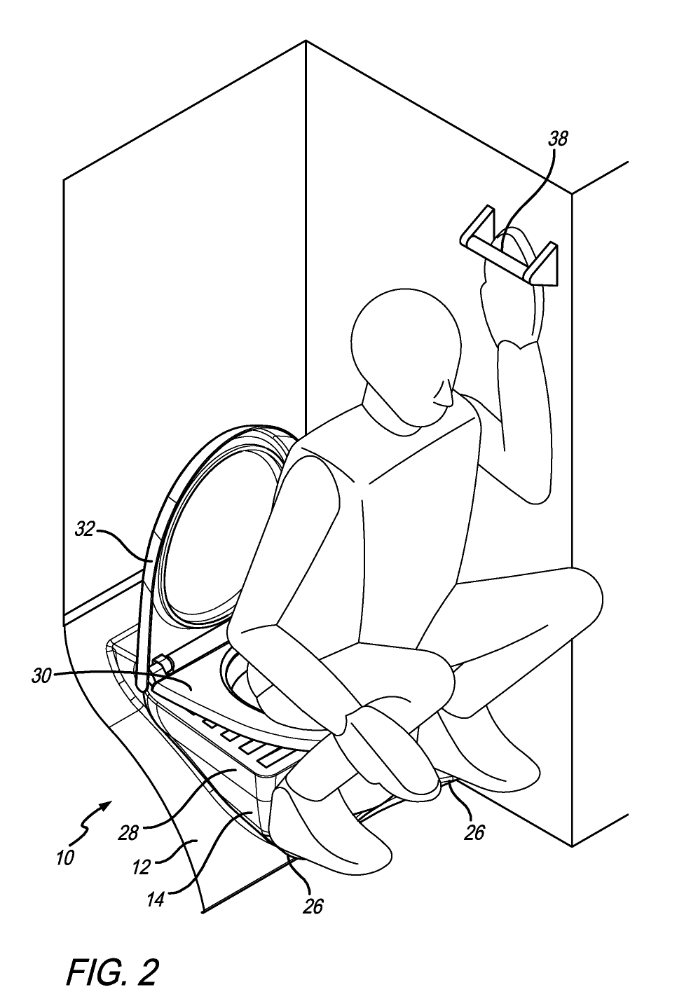

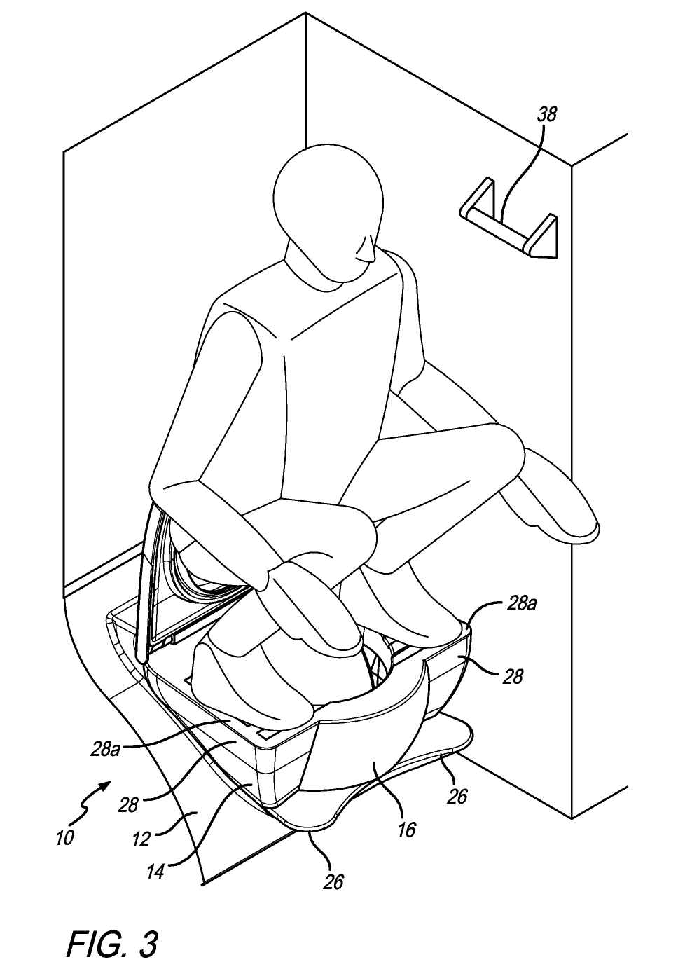

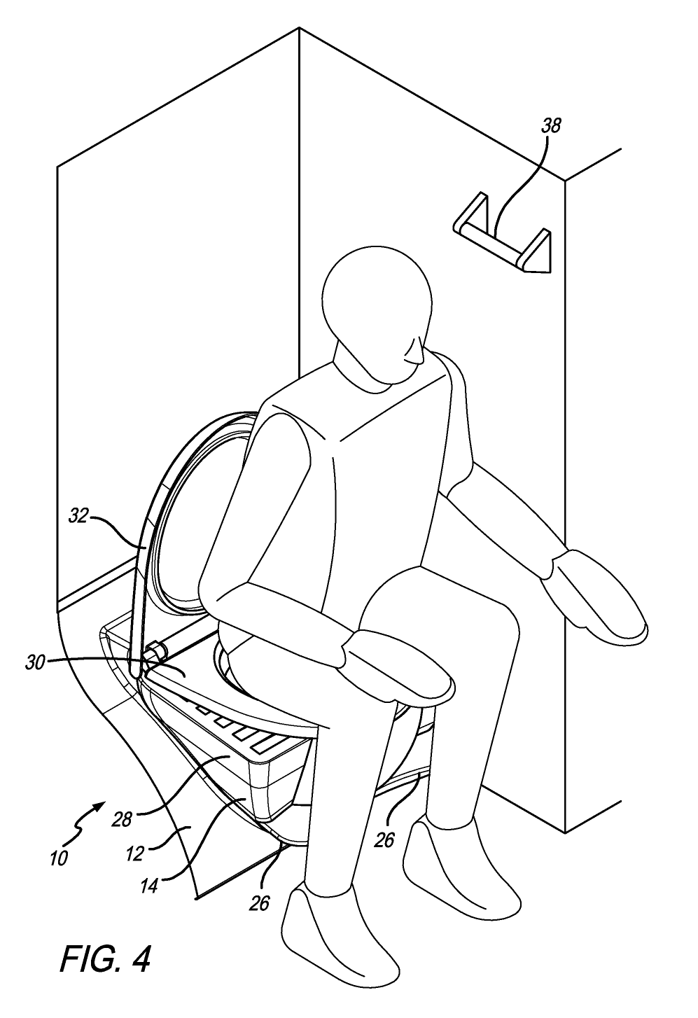

Referring now to the drawings, wherein the showings are for purposes of illustrating the present invention and not for purposes of limiting the same, FIGS. 1-4 show a toilet assembly 10 that includes multiple foot placement positions. In particular, the invention can be used in a lavatory door for commercial passenger aircraft. However, this is not a limitation on the present invention and the toilet assembly can be used elsewhere. FIG. 2 shows the toilet assembly 10 used for the intermediate position, FIG. 3 shows the toilet assembly 10 used for the squat position and FIG. 4 shows the toilet assembly 10 used in the regular position.

As shown in FIG. 1, generally, the toilet assembly 10 includes a shroud portion 12 and a main body portion 14 extending generally forwardly from the shroud portion 12. The shroud portion 12 generally has a curved or an S-shape and, in use, hides the plumbing positioned therebehind. In a preferred embodiment, the main body portion 14 includes a bowl portion 16 with a bottom 18 and a top 20. The top 20 includes an upper surface 22 that defines a seat adjacent surface 24, which is demarcated by the hidden lines in FIG. 1.

As shown in FIGS. 1 and 2, in a preferred embodiment, the bowl portion 16 includes first and second intermediate protrusions 26 extending generally forwardly and/or outwardly from the bowl portion 16. The first and second intermediate protrusions 26 are located vertically between the top 20 and the bottom 18 of the bowl portion 16. The first and second intermediate protrusions 26 each include an upper surface that defines an intermediate position surface 26a that is generally horizontal. It will be appreciated that the first and second intermediate protrusions may comprise a single long protrusion extending from the bowl portion 16, but that includes two different intermediate position surfaces 26a or places where someone can place their feet to use the toilet in the intermediate position.

As is shown in FIGS. 1 and 3, in a preferred embodiment, the bowl portion 26 includes first and second squat extension portions 28 extending outwardly therefrom (to the left and the right sides or laterally). the first and second squat extension portions 28 each include an upper surface that defines a squat position surface 28a that is generally horizontal. In a preferred embodiment, the first and second squat extension portions 28 include a front surface 28b and an outer surface 28c that are generally perpendicular to one another. It will be appreciated that the front surface 28b and outer surface 28c may not be completed flat or straight, but may include a slight curve, but that generally, as shown in FIG. 1, they are perpendicular with respect to one another. As a result, the squat position surfaces include front and outer edges that are generally perpendicular to one another.

As is shown in FIG. 3, in use, a person may put their feet on both the seat adjacent surface 24 and the squat position surfaces 28a. The seat adjacent surface 24 generally has a round or ring shape, mimicking the shape of the seat 30. In a preferred embodiment, the first and second squat extension portions 28 and the squat position surfaces generally have a rectangular shape, as shown in the figures. In a preferred embodiment, the squat position surfaces 28a include tread portions 29 thereon. The tread portions 29 preferably extend from the squat position surfaces 28a to the seat adjacent surfaces 24. The tread portions 29 can be undulations that are molded into or otherwise defined in the bowl portion 16 or can be grip tape or the like that is placed on the upper surface.

In a preferred embodiment, the toilet assembly 10 includes a pivotable seat 30 and cover 32 that are both independently movable between an open position and a closed position. In the closed position, the seat 30 covers the seat adjacent surface 24. The bowl portion 16 is generally hollow and includes an upper central opening 34 that is defined by a rim 36. In a preferred embodiment, the shroud portion 12 and main body portion 14 are unitary. For example, the shroud portion 12 and main body portion 14 can be molded from the same piece of material. In another embodiment, the shroud portion 12 and main body portion 14 can be separate pieces or components. As shown in FIGS. 2-4, in a preferred embodiment, the lavatory in which the toilet assembly 10 is positioned can include a handle 38 on the wall thereof for use during turbulence or the like.

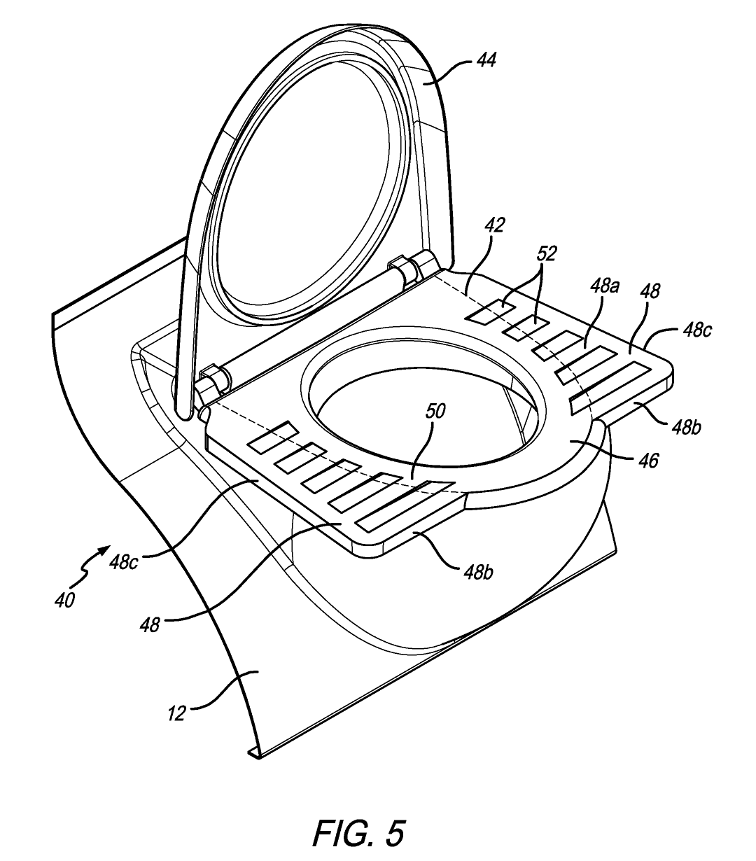

FIG. 5 shows a toilet seat assembly 40 that includes a hinged or pivotable seat portion 42 and a hinged or pivotable cover 44 in accordance with another preferred embodiment of the present invention. The seat portion 42 includes a ring portion 46 and first and second squat extension portions 48 extending outwardly from the ring portion 46 (to the left and the right sides or laterally). The ring portion 46 includes an upper surface that defines a seat surface 50. It will be appreciated by those of ordinary skill in the art that the seat surface 50 is about the size of a typical toilet seat and is demarcated by the hidden lines in FIG. 5. It will also be appreciated by those of ordinary skill in the art that the first and second extension portions 48 extend outwardly far enough from the ring portion 46 that a person can stand on them to use the toilet in the squat position. The first and second squat extension portions 48 each include an upper surface that defines a squat position surface 48a that is generally horizontal and extends outwardly from the seat surface 50. In use, a person may put their feet on both the seat surface 50 and the squat position surfaces 48a. In a preferred embodiment, the squat position surfaces 48a include tread portions 52 thereon. The tread portions 52 can be undulations that are molded into or otherwise defined in the seat portion 42 or can be grip tape or the like that is placed on the upper surface. In a preferred embodiment of the invention, the seat assembly 40 can be included with the toilet assembly 10. In this embodiment, the first and second squat extension portions 28 provide support for the first and second squat extension portions 48. In another preferred embodiment, the seat assembly 40 can be used with a regular toilet. In a preferred embodiment, the first and second squat extension portions 48 include a front surface 48b and an outer surface 48c that are generally perpendicular to one another. It will be appreciated that the front surface 48b and outer surface 48c may not be completed flat or straight, but may include a slight curve, but that generally, as shown in FIG. 5, they are perpendicular with respect to one another. As a result, the squat position surfaces 48a include front and outer edges that are generally perpendicular to one another.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. Further, any specific numbers noted herein are only examples: alternative implementations may employ differing values, measurements or ranges.

The teachings of the disclosure provided herein can be applied to other systems, not necessarily the system described above. The elements and acts of the various embodiments described above can be combined to provide further embodiments. Any measurements described or used herein are merely exemplary and not a limitation on the present invention. Other measurements can be used. Further, any specific materials noted herein are only examples: alternative implementations may employ differing materials.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A toilet assembly comprising:
a shroud portion,
a main body portion extending generally forwardly from the shroud portion, wherein the main body portion includes
a bowl portion that includes a bottom and a top, wherein the top includes an upper surface that defines a seat adjacent surface, and
first and second intermediate protrusions extending generally forwardly from the bowl portion, wherein the first and second intermediate protrusions are located vertically between the top and the bottom of the bowl portion, and wherein the first and second intermediate protrusions are configured such that a user can position their feet thereon.

2. The toilet assembly of claim 1 wherein the first and second intermediate protrusions each include an upper surface that defines an intermediate position surface that is generally horizontal.

3. The toilet assembly of claim 1 wherein the bowl portion further includes first and second squat extension portions extending outwardly therefrom, wherein the first and second squat extension portions each include an upper surface that defines a squat position surface that is generally horizontal.

4. The toilet assembly of claim 3 wherein the bowl portion includes a generally ring-shaped seat adjacent surface, and wherein the squat position surfaces extend outwardly from the seat adjacent surface.

5. The toilet assembly of claim 4 wherein the squat position surfaces include front and outer edges that are generally perpendicular to one another.

6. The toilet assembly of claim 5 wherein the first and second squat extension portions include a front surface and an outer surface that are generally perpendicular to one another.

7. The toilet assembly of claim 1 wherein the first and second intermediate protrusions are separate from one another.

8. The toilet assembly of claim 4 wherein the first and second squat extension portions include tread portions thereon.

9. The toilet assembly of claim 8 wherein the tread portions extend from the squat position surface to the seat adjacent surface.

10. A toilet assembly comprising:
a shroud portion, and
a main body portion extending generally forwardly from the shroud portion, wherein the main body portion includes a bowl portion that includes a bottom and a top, wherein the top includes an upper surface that defines a seat adjacent surface, and wherein the bowl portion further includes first and second squat extension portions extending outwardly therefrom, wherein the first and second squat extension portions each include an upper surface that defines a squat position surface that is generally horizontal.

11. The toilet assembly of claim 10 wherein the bowl portion includes a generally ring-shaped seat adjacent surface, and wherein the squat position surfaces extend outwardly from the seat adjacent surface.

12. The toilet assembly of claim 11 wherein the squat position surfaces include front and outer edges that are generally perpendicular to one another.

13. The toilet assembly of claim 12 wherein the first and second squat extension portions include tread portions thereon.

14. The toilet assembly of claim 13 wherein the tread portions extend from the squat position surface to the seat adjacent surface.

15. The toilet assembly of claim 10 further comprising first and second intermediate protrusions extending generally forwardly from the bowl portion, wherein the first and second intermediate protrusions are located vertically between the top and the bottom of the bowl portion, and wherein the first and second intermediate protrusions are configured such that a user can position their feet thereon.

16. The toilet assembly of claim 15 wherein the first and second intermediate protrusions each include an upper surface that defines an intermediate position surface that is generally horizontal.

17. A toilet seat assembly comprising:
a pivotable cover, and
a pivotable seat, wherein the pivotable seat includes a ring portion that defines a seat surface and first and second squat extension portions extending outwardly from the ring portion, wherein the first and second squat extension portions each include an upper surface that defines a squat position surface that is generally horizontal.

18. The toilet seat assembly of claim 17 wherein the squat position surfaces include front and outer edges that are generally perpendicular to one another.

19. The toilet seat assembly of claim 18 wherein the first and second squat extension portions include a front surface and an outer surface that are generally perpendicular to one another.

20. The toilet seat assembly of claim 19 wherein the first and second squat extension portions include tread portions thereon, wherein the tread portions extend from the squat position surface to the seat surface.
